(19) United States
(12) Patent Application Publication
(10) Pub. No.: US 2021/0201311 A1
(43) Pub. Date: Jul. 1, 2021

(54) METHOD FOR OPERATING ELECTRONIC DEVICE, APPARATUS AND STORAGE MEDIUM THEREOF

(71) Applicant: Tencent Technology (Shenzhen) Company Limited, Shenzhen (CN)

(72) Inventors: Rui GUO, Shenzhen (CN); Yige CAI, Shenzhen (CN); Maocai LI, Shenzhen (CN); Qing QIN, Shenzhen (CN); Jianjun ZHANG, Shenzhen (CN); Zichao TANG, Shenzhen (CN); Qingzheng SHANG, Shenzhen (CN); Chen YANG, Shenzhen (CN); Shuai ZHANG, Shenzhen (CN); Kuangdi BAO, Shenzhen (CN); Chengbo WEN, Shenzhen (CN); Yemao WANG, Shenzhen (CN); Jianming YANG, Shenzhen (CN)

(73) Assignee: Tencent Technology (Shenzhen) Company Limited, Shenzhen (CN)

(21) Appl. No.: 17/204,294

(22) Filed: Mar. 17, 2021

Related U.S. Application Data
(63) Continuation of application No. PCT/CN2019/120288, filed on Nov. 22, 2019.

(30) Foreign Application Priority Data
Dec. 5, 2018 (CN) 201811483004.4

(51) Int. Cl. G06Q 20/38; G06Q 40/02; G06F 16/23; H04L 29/06

(52) U.S. Cl. CPC G06Q 20/38215; G06Q 20/389; H04L 63/12; G06F 16/2379; G06Q 40/025

(57) ABSTRACT

A method for operating an electronic device is provided. The method includes: receiving a first resource transfer request, the first resource transfer request being used for requesting resource transfer associated with a target certificate of debt; performing verification on the first resource transfer request according to the target certificate of debt stored in a blockchain system; and performing, based on the first resource transfer request, the resource transfer associated with the target certificate of debt, in a case that the verification succeeds.

### RELATED APPLICATIONS

This application is a continuation of the PCT International Patent Application No. PCT/CN2019/120288, entitled “RESOURCE TRANSFER METHOD AND APPARATUS, ELECTRONIC DEVICE, AND STORAGE MEDIUM” and filed with National Intellectual Property Administration, PRC on Nov. 22, 2019, which claims priority to Chinese Patent Application No. 201811483004.4, filed with the National Intellectual Property Administration, PRC on Dec. 5, 2018 and entitled “RESOURCE TRANSFER METHOD AND APPARATUS, ELECTRONIC DEVICE, AND STORAGE MEDIUM.” The above applications are incorporated by reference in their entireties.

### FIELD OF THE TECHNOLOGY

This application relates to the field of blockchain technologies, and in particular, to a method, apparatus, electronic device, and a storage medium for transferring resource.

### BACKGROUND OF THE DISCLOSURE

The blockchain technology has been widely applied to a variety of fields such as the financial field, information security, computing resource sharing, entertainment, social networking, supply chain management, or medical care. A resource transfer is a common service in the financial field.

For example, data processing in these fields generally involves assets or resource transferring. Currently, a blockchain may be used as a shared ledger and may be used for recording real assets.

### SUMMARY

Embodiments of this application provide a method for operating an electronic device, apparatus, and a storage medium to resolve technical difficulties of the process of a resource transfer with a blockchain system. The technical solutions are as follows:

A resource transfer method is provided, including:

receiving a first resource transfer request, the first resource transfer request being used for requesting to perform a resource transfer associated with a target certificate of debt;

performing verification on the first resource transfer request according to the target certificate of debt stored in a blockchain system; and

performing, based on the first resource transfer request, the resource transfer associated with the target certificate of debt, in a case that the verification succeeds.

A resource transfer method is provided, including:

obtaining, when any certificate of debt meets a target condition, transfer-in and transfer-out information of a resource transfer associated with the certificate of debt;

obtaining resource information in a transfer-out account in the transfer-in and transfer-out information; and

transmitting a first resource transfer request based on the resource information and the transfer-in and transfer-out information, the first resource transfer request being used for instructing to perform verification on the first resource transfer request according to the certificate of debt stored in a blockchain system and perform, when the verification succeeds, the resource transfer associated with the certificate of debt.

A resource transfer apparatus is provided, including:

a receiving module, configured to receive a first resource transfer request, the first resource transfer request being used for requesting to perform a resource transfer associated with a target certificate of debt;

a verification module, configured to perform verification on the first resource transfer request according to the target certificate of debt stored in a blockchain system; and

a transfer module, configured to perform, based on the first resource transfer request, the resource transfer associated with the target certificate of debt, when the verification succeeds.

A resource transfer apparatus is provided, including:

an obtaining module, configured to obtain, when any certificate of debt meets a target condition, transfer-in and transfer-out information of a resource transfer associated with the certificate of debt;

the obtaining module being further configured to obtain resource information in a transfer-out account in the transfer-in and transfer-out information; and

a transmitting module, configured to transmit a first resource transfer request based on the resource information and the transfer-in and transfer-out information, the first resource transfer request being used for instructing to perform verification on the first resource transfer request according to the certificate of debt stored in a blockchain system and perform, when the verification succeeds, the resource transfer associated with the certificate of debt.

An electronic device is provided, including a processor and a memory, the memory storing at least one computer-readable instruction, the computer-readable instruction being loaded and executed by the processor to implement the following operations:

receiving a first resource transfer request, the first resource transfer request being used for requesting to perform a resource transfer associated with a target certificate of debt;

performing verification on the first resource transfer request according to the target certificate of debt stored in a blockchain system; and

performing, based on the first resource transfer request, the resource transfer associated with the target certificate of debt, when the verification succeeds.

A non-volatile computer-readable storage medium is provided, storing at least one computer-readable instruction, the computer-readable instruction being loaded and executed by a processor to implement the following operations:

obtaining, when any certificate of debt meets a target condition, transfer-in and transfer-out information of a resource transfer associated with the certificate of debt;

obtaining resource information in a transfer-out account in the transfer-in and transfer-out information; and

transmitting a first resource transfer request based on the resource information and the transfer-in and transfer-out information, the first resource transfer request being used for instructing to perform verification on the first resource transfer request according to the certificate of debt stored in the blockchain system and perform when the verification succeeds, the resource transfer associated with the certificate of debt.

### BRIEF DESCRIPTION OF THE DRAWINGS

To describe the technical solutions of the embodiments of this application more clearly, the following briefly introduces the accompanying drawings required for describing the embodiments. Apparently, the accompanying drawings in the following description show only some embodiments of this application, and a person of ordinary skill in the art may still derive other drawings from these accompanying drawings without creative efforts.

FIG. 1 is a diagram of an implementation environment of a resource transfer method according to an embodiment of this disclosure.

FIG. 2 is a diagram of an implementation environment of a resource transfer method according to an embodiment of this disclosure.

FIG. 3 is a diagram of an implementation environment of a resource transfer method according to an embodiment of this disclosure.

FIG. 4 is a flowchart of a resource transfer method according to an embodiment of this disclosure.

FIG. 5 is a flowchart of a resource transfer method according to an embodiment of this disclosure.

FIG. 6 is a schematic structural diagram of a resource transfer apparatus according to an embodiment of this disclosure.

FIG. 7 is a schematic structural diagram of a resource transfer apparatus according to an embodiment of this disclosure.

FIG. 8 is a schematic structural diagram of a terminal according to an embodiment of this disclosure.

FIG. 9 is a schematic structural diagram of a server according to an embodiment of this disclosure.

### DESCRIPTION OF EMBODIMENTS

To make the objectives, technical solutions, and advantages of this application clearer, the following further describes implementations of this application in detail with reference to the accompanying drawings.

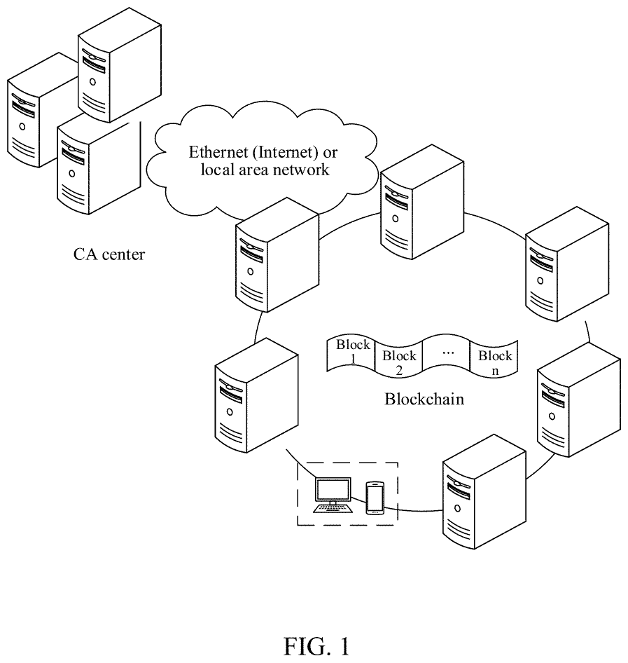

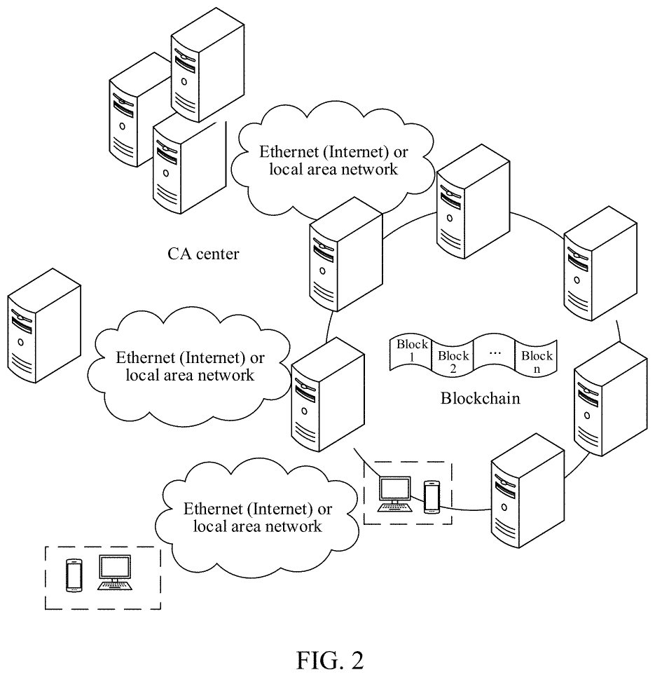

FIG. 1 and FIG. 2 are diagrams of implementation environments of a resource transfer method according to an embodiment of this disclosure. Referring to FIG. 1 and FIG. 2, the implementation environment may include a plurality of electronic devices, and each electronic device may be a terminal, or may be a server.

As shown in FIG. 1, the plurality of electronic devices may be a plurality of node devices in a blockchain system. As shown in FIG. 2, the plurality of electronic devices may alternatively include an electronic device outside the blockchain system and a plurality of node devices in the blockchain system. A specific implementation is not limited in this embodiment of this disclosure.

The plurality of electronic devices in the blockchain system may be a plurality of node devices belonging to the same organization or belonging to different organizations. For example, the plurality of electronic devices may all belong to a financial institution but belong to different departments of the financial institution; alternatively, one or more of the electronic devices may be user equipment and the one or more electronic devices belong to a financial institution. The system may include servers in organizations within a consortium. Certainly, other electronic devices may further belong to other organizations such as an asset management organization, and details are not listed one by one in the embodiments of this application.

In a supply chain financial scenario, the plurality of electronic devices may correspond to different organizations, for example, a core enterprise, a supplier, an asset management organization, a financial institution, or another organization having a contract relationship with the financial institution. An asset management platform may be deployed on a device of the asset management organization, and a device of the financial institution or the another organization having the contract relationship with the financial institution may be a resource transfer device.

The asset management platform may verify a certificate of debt generation request or a certificate of debt transfer request submitted by the supplier and generate a certificate of debt when the verification succeeds. The asset management platform may further implement resource transfer based on the certificate of debt together with the resource transfer device when the certificate of debt expires. Certainly, in the scenario of transferring the certificate of debt, a specific generation condition may further be provided when a new certificate of debt is generated. For example, the new certificate of debt is available or valid after a specific quantity of resources are transferred.

The resource transfer device may maintain resource information in a plurality of accounts or may perform a resource transfer on a resource in an account. Certainly, the resource transfer device may further be an agent device for resource transfer, and the resource transfer device may implement a resource transfer function through a resource transfer interface provided by the financial institution. In this embodiment of this disclosure, the asset management platform may transmit a resource transfer request to the resource transfer device, and the resource transfer device provides a resource transfer service for the asset management platform.

The device in which the asset management platform is located and the resource transfer device may be node devices in the blockchain system, and a device of the core enterprise and a device of the supplier may be node devices in the blockchain system. Certainly, the device of the core enterprise and the device of the supplier may alternatively be node devices outside the blockchain system. This is not limited in this embodiment of this disclosure. In a possible implementation, the asset management platform may be deployed on one electronic device, or may be deployed on a plurality of electronic devices in a distributed manner. For example, the asset management platform may be deployed on one server, or may be deployed on one server cluster, which are all referred to as the device in which the asset management platform is located. This is not specifically limited in this embodiment of this disclosure.

Certainly, to perform services such as security verification and permission management, a blockchain system may be configured with a certificate authority (CA) center, configured to store encryption keys of organizations. Electronic devices in the blockchain system may obtain the encryption keys of the organizations from the CA center, to perform processes such as information encryption and information decryption.

The following further describes the terms mentioned in the embodiments of this application and a specific application scenario of the resource transfer method.

The certificate of debt mentioned in the resource transfer method provided in the embodiments of this application may be digital assets, the certificate of debt usually has an expiration time, and a debtor may transfer a resource in the certificate of debt to a creditor at the expiration time of the certificate of debt. Certainly, the certificate of debt may be generated in different manners. Specifically, the generation of the certificate of debt may include the following three scenarios.

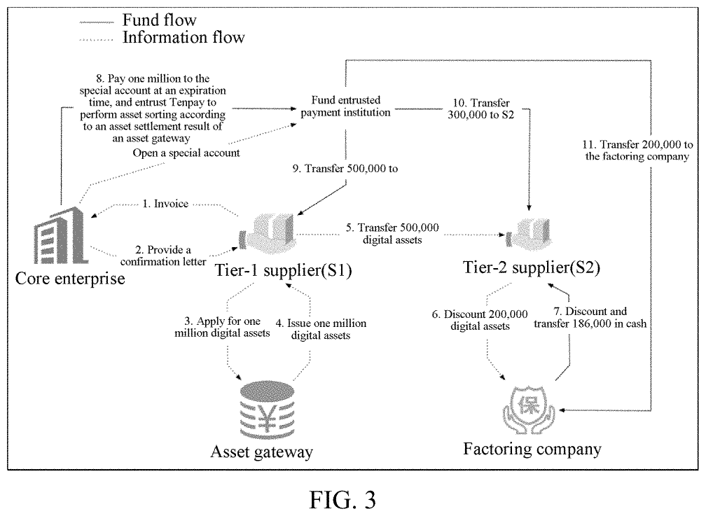

In a first possible scenario, a first account submits a request, and the blockchain system generates a first certificate of debt for the first account when a second account makes a confirmation. The first certificate of debt is used for indicating that a first resource in the second account is transferred to the first account at an expiration time. Specifically, the certificate of debt may be digital assets in a service held until expiration. A supplier may hold the certificate of debt. At the expiration time of the certificate of debt, a core enterprise may tender payment in the certificate of debt to the supplier. Therefore, the certificate of debt may be regarded as an electronic confirmation letter, that is, receivables held by the supplier after the core enterprise makes a confirmation. For example, as shown in FIG. 3, a tier-1 supplier applies for one million digital assets, and the blockchain system issues the one million digital assets when a core enterprise makes a confirmation. The one million digital assets are the first certificate of debt.

In a second possible scenario, the first account submits a request based on the first certificate of debt, and the blockchain system generates a second certificate of debt for a third account. The second certificate of debt is used for indicating that a second resource in the first resource of the first account is transferred to the third account at an expiration time. That is, some or all resources in the certificate of debt held by the first account are transferred to the third account. For example, as shown in FIG. 3, a tier-1 supplier (S1) holds one million digital assets of a core enterprise, and the one million digital assets are a certificate of debt. The tier-1 supplier transfers half of the one million digital assets to a tier-2 supplier (S2), and the tier-2 supplier holds another certificate of debt of the tier-1 supplier. The two certificate of debts are associated, and the certificate of debt held by the tier-2 supplier is the transferred 500,000 digital assets.

In a third possible scenario, the first account or the third account submits a request based on the held certificate of debt, and the blockchain system generates a third certificate of debt. The third certificate of debt is used for indicating that a third resource in the second resource or the first resource is transferred to a fourth account at a target time, and a generation condition of the third certificate of debt is that the fourth account needs to transfer a fourth resource to the first account or the third account. After the fourth account performs the resource transfer, the third certificate of debt is available and valid. For example, the tier-1 supplier and the tier-2 supplier may discount the held digital assets, and the discounting process is also a process of transferring the certificate of debt. The supplier may transfer some or all resources in the held certificate of debt to a financial institution or another organization having a contract relationship with the financial institution, the financial institution or the another organization having a contract relationship with the financial institution charges a specific discount fee and may pay the supplier less than the share of the transferred digital assets, so that the financial institution or the another organization having a contract relationship with the financial institution may hold the transferred certificate of debt. In this case, the certificate of debt has a generation condition.

For example, as shown in FIG. 3, the tier-2 supplier holds 500,000 digital assets of the tier-1 supplier and applies to a factoring company or a bank for discounting 200,000 digital assets in the 500,000 digital assets, and the factoring company or the bank may charge a specific discount fee, for example, 14,000 digital assets. When determining to sign for the 200,000 digital assets, the factoring company or the bank may pay 186,000 funds to the tier-2 supplier. The funds are paid to the tier-2 supplier currently instead of in the future, so that the factoring company or the bank can hold the 200,000 digital assets, or the 200,000 digital assets may be considered as available and valid.

The generation manner of the certificate of debt is described above by using the three possible scenarios, and the generation manner of the certificate of debt may also include other possible scenarios, which are not limited in this embodiment of this disclosure.

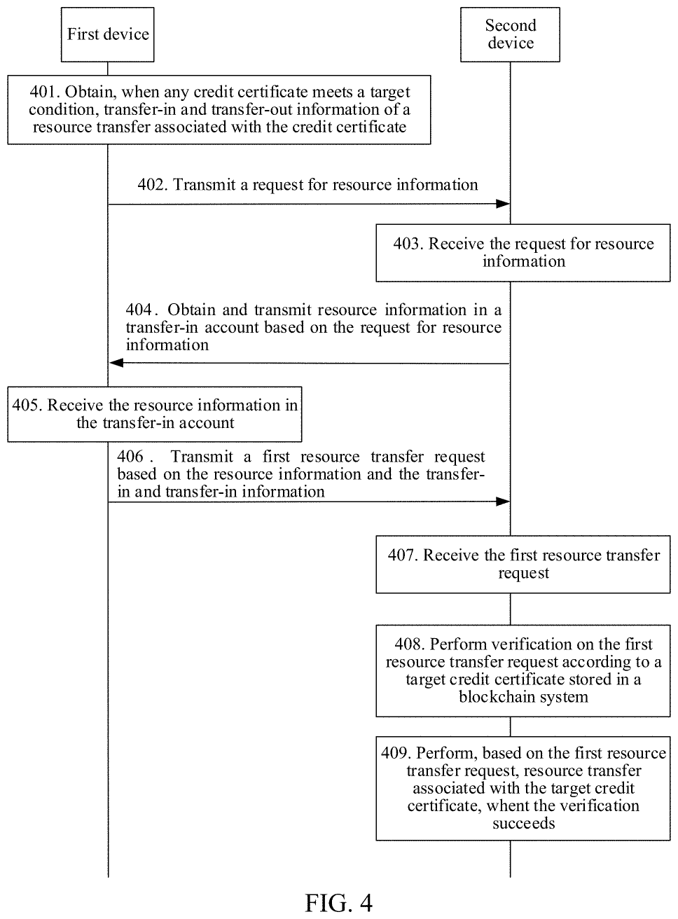

The following describes, through an embodiment shown in FIG. 4, a case that a first device interacts with a second device to implement resource transfer in detail. The first device and the second device are electronic devices. Specifically, the first device may be a device in which the asset management platform is located, and the second device may be the resource transfer device. FIG. 4 is a flowchart of a resource transfer method according to an embodiment of this disclosure. Referring to FIG. 4, the method may include the following steps.

Step 401. A first device obtains, when any certificate of debt meets a target condition, transfer-in and transfer-out information of a resource transfer associated with the certificate of debt.

In this embodiment of this disclosure, when a certificate of debt meets a target condition, resource transfer associated with the certificate of debt may be implemented through interaction between the first device and the second device. In step 401, when the certificate of debt meets the target condition, the first device may determine that the resource transfer associated with the certificate of debt needs to be performed. Specifically, the first device may obtain the transfer-in and transfer-out information of the resource transfer associated with the certificate of debt, and further determine, based on the transfer-in and transfer-out information, whether a condition of the resource transfer is met currently, that is, determine whether the resource transfer can be performed currently.

According to the content of the embodiment shown in FIG. 3, the certificate of debt may be generated in different manners. In step 401, because the certificate of debt may be generated in different manners, different target conditions may be set for trigger of the resource transfer, and the resource transfer associated with the certificate of debt may also be different.

For example, for some certificates of debt, generation conditions have been determined when the certificates of debts are generated. Such a certificate of debt is available and valid only after a resource transfer indicated by the generation condition is performed. Certainly, the resource transfer may alternatively be performed at an expiration time of the certificate of debt having the generation condition. Therefore, for such certificates of debts, the certificate of debt may be associated with two types of resource transfers. However, some certificates of debts are generated without generation condition. For such a certificate of debt, a resource transfer is performed at an expiration time. Therefore, for such certificates of debts, the certificate of debt may be associated with one type of resource transfer.

In a possible implementation, as the generation condition of the certificate of debt, the target condition, and the resource transfer associated with the certificate of debt vary, the transfer-in and transfer-out information obtained by the first device also varies. The following describes a process of step 401 in detail by using two cases.

In the first case, when the certificate of debt is generated and the certificate of debt has a generation condition, the first device obtains transfer-in and transfer-out information in the generation condition.

The first case corresponds to the third possible scenario in the embodiment shown in FIG. 3, which mainly describes a process of how the first device starts to perform the resource transfer in the generation condition when the certificate of debt is generated and the certificate of debt has the generation condition. In the first case, the target condition will be met when the certificate of debt is generated and the certificate of debt has the generation condition. In this case, the first device is to perform the resource transfer indicated by the generation condition. Therefore, the first device may obtain the transfer-in and transfer-out information in the generation condition when determining the transfer-in and transfer-out information of the resource transfer.

In a possible implementation, the transfer-in and transfer-out information may include transfer-in and transfer-out account information, a to-be-transferred resource, and creditor information of the certificate of debt.

Still using the third possible scenario in the embodiment shown in FIG. 3 as an example, the certificate of debt is used for indicating that a third resource of a first resource in a first account is transferred to a fourth account at a target time, and the generation condition of the certificate of debt is that the fourth account needs to transfer a fourth resource to the first account. Therefore, when the certificate of debt is generated, the first device may obtain transfer-in and transfer-out information in the generation condition. Specifically, a transfer-in account is the first account, a transfer-out account is the fourth account, a to-be-transferred resource is the fourth resource, and creditor information of the certificate of debt is owner information of the fourth account.

For example, a tier-2 supplier applies to a factoring company for discounting 200,000 digital assets, and the generation condition of the certificate of debt is that the factoring company transfers 186,000 funds to the tier-2 supplier. When the certificate of debt is generated based on the application of the tier-2 supplier, the first device may obtain transfer-in and transfer-out information in the generation condition. A transfer-in account is an account of the tier-2 supplier, a transfer-out account is an account of the factoring company, a to-be-transferred resource is 186,000 funds, and creditor information of the certificate of debt may be information about the factoring company.

In the second case, the first device obtains, when a system time is an expiration time of the certificate of debt, transfer-in and transfer-out information of the resource transfer indicated by the certificate of debt.

The second case corresponds to a case that a corresponding resource transfer is performed at the expiration time of the certificate of debt in the three possible scenarios in the embodiment shown in FIG. 3. In this case, the certificate of debt may or may not have a generation condition when being generated, and the first device may perform the resource transfer indicated by the certificate of debt when the certificate of debt expires. Therefore, the first device may obtain the transfer-in and transfer-out information of the resource transfer indicated by the certificate of debt.

In a possible implementation, the transfer-in and transfer-out information may include transfer-in and transfer-out account information, a to-be-transferred resource, and an expiration time of the target certificate of debt.

The first possible scenario in the supply chain financial scenario is used as an example, that is, that the certificate of debt is used for indicating that the first resource in the first account is to be transferred to the second account at the target time is used as an example. In the second case, the system time is the expiration time of the certificate of debt, that is, the system time is the target time, indicating that the certificate of debt has expired, and the first device needs to interact with the second device, to perform the resource transfer indicated by the certificate of debt. The first device may obtain transfer-in and transfer-out information of the resource transfer indicated by the certificate of debt. A transfer-in account is the second account, a transfer-out account is the first account, a to-be-transferred resource is the first resource, and an expiration time of the target certificate of debt is the target time.

For example, a tier-1 supplier holds one million digital assets of a core enterprise, and the one million digital assets expire on MM/DD/YY. On MM/DD/YY, the first device may perform step 401 to obtain transfer-in and transfer-out information corresponding to the one million digital assets. A transfer-in account is an account of the tier-1 supplier, a transfer-out account is an account of the core enterprise, a to-be-transferred resource is the one million digital assets, and an expiration time of the certificate of debt is MM/DD/YY.

The two cases are described merely by using an example in which the transfer-in and transfer-out information includes the aforementioned information, and the transfer-in and transfer-out information may further include other information. This is not limited in this embodiment of this disclosure.

In a specific possible embodiment, the first device may be a node device in a blockchain system, and the first device may maintain an account table. In the three possible scenarios, when the certificate of debt is generated, the first device may update, according to the certificate of debt, information about an account associated with the certificate of debt. Therefore, the first device may determine, based on information about accounts in the account table, whether the certificate of debt meets the target condition, and perform step 401 when the certificate of debt meets the target condition.

Step 402. The first device transmits a resource information obtaining request to a second device, the request for resource information being used for obtaining resource information in a transfer-out account.

After obtaining the transfer-in and transfer-out information, the first device may further determine whether a transfer-out account includes a to-be-transferred resource, that is, determine whether the transfer-out account is capable of transferring out the to-be-transferred resource. It may be understood that if the transfer-out account does not include the to-be-transferred resource, when a resource transfer is performed, the resource transfer fails as a result of insufficient of resources in the transfer-out account. Therefore, that the transfer-out account includes the to-be-transferred resource is a precondition for a successful resource transfer.

The second device may maintain resource information in a plurality of accounts, and another electronic device may transmit a request for resource information to the second device to request the second device to provide resource information in any account. For example, the second device may store asset situations in a plurality of accounts, for example, balances in the accounts. Therefore, after step 401, the first device may obtain the resource information in the transfer-out account by transmitting the request for resource information to the second device.

403. The second device receives the request for resource information.

In this embodiment of this disclosure, after receiving the request for resource information transmitted by the first device, the second device may perform the following step 404 to obtain the resource information in the transfer-out account.

404. The second device obtains the resource information in the transfer-out account and transmits the resource information in the transfer-out account to the first device based on the request for resource information.

In a possible implementation, the request for resource information may carry identification information of the transfer-out account, so that the second device may obtain resource information corresponding to the identification information based on the identification information carried in the request for resource information. The resource information corresponding to the identification information is the resource information in the transfer-out account. The identification information may be an account number of the account, identity information of an owner of the account, or the like.

In a specific possible embodiment, the request for resource information may further carry an account password of the transfer-out account, so that the second device may determine whether the account password is correct, and may perform step 404 when determining that the account password is correct. In another specific possible embodiment, the request for resource information may not carry the account password. A rule of the request for resource information may be pre-established between the first device and the second device. For example, the first device may obtain resource information in an account without an account password, but the request for resource information needs to carry identification information of the first device, and when determining, based on the identification information of the first device, that the request for resource information is a request transmitted by the first device, the second device performs step 404. Certainly, a resource information obtaining step may alternatively be performed without establishing the rule between the first device and the second device. A specific implementation to be used is not limited in this embodiment of this disclosure.

The second device may provide a resource information obtaining service. A process of providing the resource information obtaining service by the second device may be as follows: the second device may receive the request for resource information, the request for resource information being used for obtaining resource information in any account. The second device may obtain and transmit the resource information in the any account based on the request for resource information. The resource information obtaining service of the second device is used in step 403 and step 404.

Step 405. The first device receives the resource information in the transfer-out account.

Step 402 to step 405 is a process of obtaining the resource information in the transfer-out account in the transfer-in and transfer-out information by the first device. After obtaining the resource information in the transfer-out account, the first device may perform the following step to determine whether the transfer-out account includes the to-be-transferred resource, thereby determining whether the transfer-out account can meet a requirement of the current resource transfer.

Step 406. The first device transmits first request for transferring the resource to the second device based on the resource information and the transfer-in and transfer-out information.

After obtaining the resource information of the transfer-out account, the first device may determine, based on the resource information and the transfer-in and transfer-out information, whether the transfer-out account is capable of transferring the to-be-transferred resource. It may be understood that measures taken by the first device may vary depending on whether the transfer-out account includes the to-be-transferred resource, that is, the first device may process the transfer-in and transfer-out information in different manners. In addition, even if the transfer-out account includes the to-be-transferred resource, in the first case in step 401, the transfer-out account in the generation condition further needs to confirm whether to sign for the certificate of debt, and the resource transfer needs to be performed when a confirmation is made. Therefore, corresponding to the two cases in step 401, step 406 may also include two cases.

Case 1: When determining, according to the resource information, that the transfer-out account includes a to-be-transferred resource in the transfer-in and transfer-out information and obtaining a confirmation instruction of the transfer-out account, the first device transmits the first resource transfer request to the second device.

In case 1, the transfer-out account in the generation condition further needs to confirm whether to sign for the certificate of debt, and the resource transfer needs to be performed when a confirmation is made, so that the first device transmits the first resource transfer request to the second device, the first resource transfer request being used for instructing to perform the resource transfer in the generation condition of the certificate of debt. Therefore, a trigger condition of the first resource transfer request may be as follows: the transfer-out account is capable of transferring the to-be-transferred resource while the transfer-out account confirms to sign for the to-be-transferred resource. When the trigger condition of the first resource transfer request is met, the first device may automatically trigger transmission of the first resource transfer request to the second device.

In a possible implementation, when determining, according to the resource information, that the transfer-out account includes the to-be-transferred resource in the transfer-in and transfer-out information, the first device may transmit a confirmation request to a device corresponding to the transfer-out account. The device may display a confirmation notification when receiving the confirmation request, and a user of the transfer-out account may perform a confirmation operation, so that when obtaining a confirmation instruction triggered by the confirmation operation, the device may transmit the confirmation instruction to the first device, and the first device obtains the confirmation instruction of the transfer-out account.

In another possible implementation, in step 401, after the certificate of debt is generated, the device corresponding to the transfer-out account may display the confirmation notification, and the user of the transfer-out account may perform the confirmation operation, to trigger transmission of the confirmation instruction to the first device. Certainly, in this implementation, there may be another possible case. The device corresponding to the transfer-out account may transmit the confirmation instruction to the first device only when the first device determines that the transfer-out account includes the to-be-transferred resource. A specific implementation to be used is not limited in this embodiment of this disclosure.

For example, a tier-2 supplier applies to a factoring company for discounting 200,000 digital assets, and the generation condition of the certificate of debt is that the factoring company transfers 186,000 funds to the tier-2 supplier. A transfer-out account is an account of the factoring company, and a to-be-transferred resource is the 186,000 funds. When determining that an account balance of the factoring company is greater than or equal to 186,000, the first device may allow the factoring company to sign for the 200,000 digital assets, that is, sign for the certificate of debt. A worker of the factoring company may perform a confirmation operation, so that the first device may obtain a confirmation instruction of the factoring company. Therefore, a payment process may be automatically triggered.

Case 2: When determining, according to the resource information, that the transfer-out account includes the to-be-transferred resource in the transfer-in and transfer-out information, the first device transmits the first resource transfer request to the second device.

In case 2, the current resource transfer is a resource transfer required when the certificate of debt expires. The resource transfer indicated by the certificate of debt has been confirmed by transfer-in and transfer-out accounts when the certificate of debt is generated. Therefore, no further confirmation is needed. When determining that the transfer-out account includes the to-be-transferred resource, the first device may trigger transmission of the first resource transfer request, that is, when it is determined that the transfer-out account is capable of transferring the to-be-transferred resource, the first resource transfer request may be automatically transmitted. The first resource transfer request is used for instructing to perform, at the expiration time of the certificate of debt, the resource transfer indicated by the certificate of debt.

For example, a tier-1 supplier holds one million digital assets of a core enterprise, and the one million digital assets expire on MM/DD/YY. On MM/DD/YY, when the first device determines, through step 401 to step 406, that an account balance of the core enterprise is sufficient to pay one million, a payment process may be automatically triggered.

The first resource transfer request in the two cases is used for instructing to perform verification on the first resource transfer request according to the certificate of debt stored in the blockchain system and perform and to perform the resource transfer associated with the certificate of debt when the verification succeeds. For a specific description, reference may be made to the following step 408 and step 409. Details are not described in this embodiment of this disclosure.

Step 407. The second device receives the first resource transfer request.

The first resource transfer request is used for requesting to perform a resource transfer associated with a target certificate of debt. The target certificate of debt is the certificate of debt meeting the target condition in step 401. In a possible implementation, the first resource transfer request may carry the transfer-in and transfer-out information, so that the second device may perform verification on the first resource transfer request by performing the following step 408.

Step 408. The second device performs verification on the first resource transfer request according to the target certificate of debt stored in a blockchain system.

After receiving the first resource transfer request, the second device may perform the verification on the first resource transfer request according to information stored in the blockchain system to determine authenticity of the first resource transfer request. The transfer of a physical resource is verified through a digital resource on a blockchain, so that resource information on the blockchain is associated with the transfer of physical resources, thereby effectively resolving disconnection between the transfer of physical resources and the digital resource on the blockchain in the payment process.

Specifically, a process of performing the verification on the first resource transfer request by the second device in step 408 may include the following step 1 and step 2.

Step 1. The second device determines, according to a feature value carried in the first resource transfer request, a certificate of debt from the blockchain system corresponding to the feature value as a target certificate of debt.

Before performing the verification on the first resource transfer request, the second device needs to obtain an information basis required for the verification. The information basis required for the verification is the target certificate of debt, and the target certificate of debt may be stored in a blockchain of the blockchain system. In a possible implementation, on the blockchain, a certificate of debt may be correspondingly stored with a feature value of the certificate of debt. The first resource transfer request may carry a feature value of the target certificate of debt, so that the second device may determine the target certificate of debt based on the feature value and use the target certificate of debt as the basis for verifying the first resource transfer request.

For example, the feature value may be a hash value of the certificate of debt, and the hash value may be obtained by performing hash calculation on the certificate of debt before storing the certificate of debt in the blockchain by the blockchain system.

Step 2. The second device compares transfer-in and transfer-out information in the target certificate of debt stored in the blockchain system with transfer-in and transfer-out information carried in the first resource transfer request.

After determining the target certificate of debt, the second device may perform the verification on the first resource transfer request by using the target certificate of debt as a basis. Specifically, the verification process may be as follows: the second device compares the transfer-in and transfer-out information in the target certificate of debt with the transfer-in and transfer-out information carried in the first resource transfer request, and there may be two verification results after the comparison.

When the transfer-in and transfer-out information in the target certificate of debt stored in the blockchain system matches the transfer-in and transfer-out information carried in the first resource transfer request, the second device may determine that the verification succeeds. Then, the second device may perform the following step 409 to implement the resource transfer.

When the transfer-in and transfer-out information in the target certificate of debt stored in the blockchain system does not match the transfer-in and transfer-out information carried in the first resource transfer request, the second device may determine that the verification fails.

In a possible implementation, the first resource transfer request may further carry indication of a resource transfer type. Based on the content shown in step 401, the transfer-in and transfer-out information obtained in the two cases is different. The indication of resource transfer type carried in the first resource transfer request transmitted in step 406 varies with different transfer-in and transfer-out information. Correspondingly, with the different pieces of indications of the resource transfer types, the transfer-in and transfer-out information to be compared in step 408 varies. Correspondingly, step 2 in step 408 may be as follows: the second device selects, from the target certificate of debt stored in the blockchain system and according to a resource transfer type carried in the first resource transfer request, transfer-in and transfer-out information corresponding to the indication of the resource transfer type, to be compared with the transfer-in and transfer-out information carried in the first resource transfer request.

Specifically, corresponding to the two cases mentioned in step 401, that is:

In the first case, when the certificate of debt is generated and the certificate of debt has a generation condition, the transfer-in and transfer-out information is the transfer-in and transfer-out information in the generation condition, and the transfer-in and transfer-out information may include the transfer-in and transfer-out account information, the to-be-transferred resource, and the creditor information of the certificate of debt. Correspondingly, the resource transfer type is a first type.

In the second case, when the system time is the expiration time of the certificate of debt, the transfer-in and transfer-out information is the transfer-in and transfer-out information of the resource transfer indicated by the certificate of debt, and the transfer-in and transfer-out information may include the transfer-in and transfer-out account information, the to-be-transferred resource, and the expiration time of the target certificate of debt. Correspondingly, the resource transfer type is a second type.

In this case, the step(s) performed by the second device in step 2 of step 408 needs to perform may also include the following two cases.

Case 1: The second device selects, when the resource transfer type is the first type, transfer-in and transfer-out account information, a to-be-transferred resource, and creditor information of the target certificate of debt from the target certificate of debt stored in the blockchain system, to respectively compare with transfer-in and transfer-out account information, a to-be-transferred resource, and creditor information of the target certificate of debt that are carried in the first resource transfer request. The first type of resource transfer is used for instructing to perform a resource transfer in a generation condition of the target certificate of debt.

In case 1, the transfer-in and transfer-out information carried in the first resource transfer request may include the transfer-in and transfer-out account information, the to-be-transferred resource, and the creditor information of the target certificate of debt. When performing comparison in step 2, the second device may compare corresponding information in the target certificate of debt with the foregoing information, to determine whether the transfer-in and transfer-out information carried in the first resource transfer request is consistent with information on the blockchain, thereby determining authenticity of the first resource transfer request.

For example, corresponding to the third possible scenario in the embodiment shown in FIG. 3, a tier-2 supplier applies to a factoring company for discounting 200,000 digital assets, and the factoring company pays 186,000 funds to the tier-2 supplier. After the factoring company confirms the receipt, the first device transmits a payment request to the second device. After receiving the payment request, the second device may obtain, from the blockchain, transfer-in and transfer-out information associated with the 200,000 digital assets. This payment type is discount payment. Therefore, the second device checks, according to the transfer-in and transfer-out information on the blockchain, whether a transfer-in account (an account of the tier-2 supplier) is correct, whether a transfer-out account (an account of the factoring company) is correct, whether a transfer share is 186,000, and whether information about the factoring company is correct in the payment request. When all the information is correct, verification on the payment request succeeds. The payment request is the first resource transfer request, and the discount payment is the first type of resource transfer.

Case 2: The second device selects, when the resource transfer type is the second type, transfer-in and transfer-out account information, a to-be-transferred resource, and an expiration time of the target certificate of debt from the target certificate of debt stored in the blockchain system, to respectively compare with transfer-in and transfer-out account information, a to-be-transferred resource, and an expiration time of the target certificate of debt that are carried in the first resource transfer request. The second type of resource transfer is used for instructing to perform, at the expiration time of the target certificate of debt, a resource transfer indicated by the target certificate of debt.

In case 2, the transfer-in and transfer-out information carried in the first resource transfer request may include the transfer-in and transfer-out account information, the to-be-transferred resource, and the expiration time of the target certificate of debt. When performing comparison in step 2, the second device may compare corresponding information in the target certificate of debt with the foregoing information, to determine whether the transfer-in and transfer-out information carried in the first resource transfer request is consistent with information on the blockchain, thereby determining authenticity of the first resource transfer request.

For example, corresponding to the first possible scenario in the embodiment shown in FIG. 3, a tier-1 supplier holds one million digital assets of a core enterprise. When an account of the core enterprise is sufficient to pay one million, the first device transmits a payment request to the second device. After receiving the payment request, the second device may obtain, from the blockchain, transfer-in and transfer-out information associated with the one million digital assets. This payment type is due payment. Therefore, the second device checks, according to the transfer-in and transfer-out information on the blockchain, whether a transfer-out account (an account of the core enterprise) is correct, whether a transfer-in account (an account of the tier-1 supplier) is correct, whether a transfer share is one million, and whether an expiration time (MM/DD/YY) is correct in the payment request. When all the information is correct, verification on the payment request succeeds. The payment request is the first resource transfer request, and the due payment is the second type.

The two cases are described merely by using an example in which the transfer-in and transfer-out information includes the aforementioned information, and the transfer-in and transfer-out information may further include other information. This is not limited in this embodiment of this disclosure.

Step 409. When the verification succeeds, the second device performs, based on the first resource transfer request, a resource transfer associated with the target certificate of debt.

After performing the verification on the first resource transfer request, if the verification succeeds, the second device may perform step 409 to perform the resource transfer. Specifically, the to-be-transferred resource in the transfer-out account may be transferred to the transfer-in account.

In a possible implementation, a resource transfer service provided by the second device is an agent resource transfer service. The second device may interact with a financial institution, the financial institution performs a resource transfer, and the second device provides the proxy agent transfer service. Correspondingly, step 409 may be as follows: the second device transmits a second resource transfer request to a target device, and the target device performs the resource transfer based on the second resource transfer request, the second resource transfer request being used for instructing to perform the resource transfer requested in the first resource transfer request. In a specific possible embodiment, the target device may be provided with a target interface, and the second device may transmit the second resource transfer request to the target device through the target interface.

The target device may be a device in which the financial institution is located, and the target device may provide the resource transfer service. Based on step 401 to step 408, when the second device determines to perform the resource transfer, the second device may transmit the second resource transfer request to the target device.

After step 409, and the current resource transfer is finished, the second device may further generate a first block based on a result of the resource transfer associated with the target certificate of debt, and add the first block to a blockchain when the blockchain system reaches a consensus on the first block. In this way, after performing the resource transfer, the second device may record the result of the resource transfer on the blockchain, so that the current resource transfer process ends, and information about the current resource transfer is recorded on the blockchain.

The foregoing merely describes a case that the second device performs the resource transfer when the verification succeeds, and after step 408, there is another possible scenario when the verification fails. In such a scenario, the second device may also record a processing result of the first resource transfer request on the blockchain. Specifically, the second device generates a second block based on a result of the verification when the verification fails, and adds the second block to the blockchain when the blockchain system reaches a consensus on the second block. In a possible implementation, when the verification fails, the second device may further transmit a resource transfer failure message to the first device.

After step 407, that is, after receiving the first resource transfer request, the second device may generate a resource transfer bill based on the first resource transfer request, and store the resource transfer bill in a bill database. The bill database is used for storing the resource transfer bill.

In a possible implementation, when generating the resource transfer bill based on the first resource transfer request, the second device may further generate the resource transfer bill corresponding to the resource transfer type based on the resource transfer type carried in the first resource transfer request.

Correspondingly, after step 409, the second device may alternatively update a state of the resource transfer bill in the bill database based on the result of the resource transfer associated with the target certificate of debt. Specifically, the result of the resource transfer may be success or failure. If the result of the resource transfer is success, the second device may set the state of the resource transfer bill in the bill database to a transfer success state. If the result of the resource transfer is failure, the second device may set the state of the resource transfer bill in the bill database to a transfer failure state.

Certainly, if it is determined that the verification fails after step 408, the second device may also update the state of the resource transfer bill in the bill database based on the result of the verification.

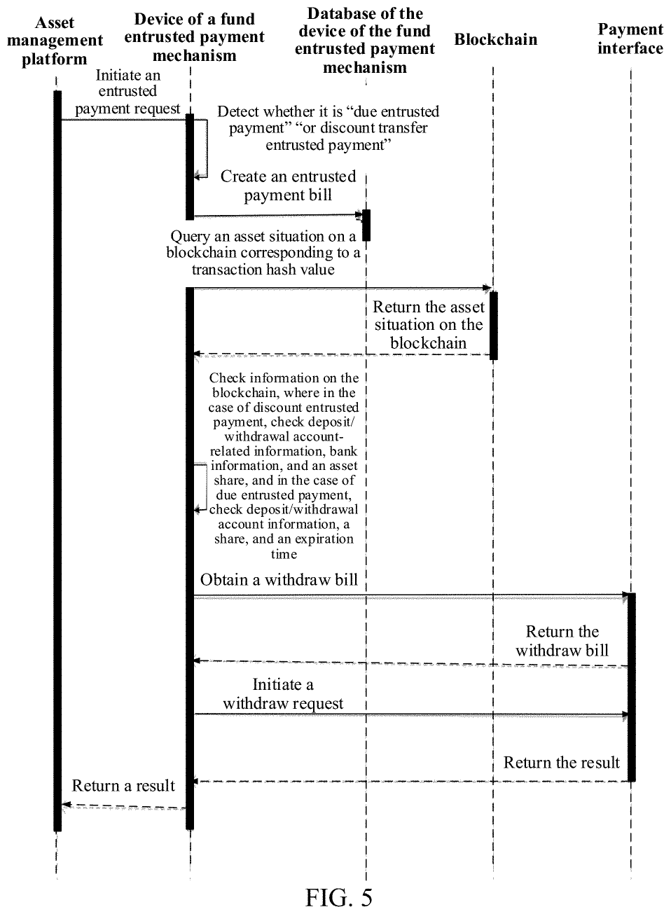

For example, as shown in FIG. 5, an asset management platform is deployed on the first device, and the second device is a device of a fund entrusted payment mechanism. Herein, a resource is referred to as a fund. In step 401 to step 406, the asset management platform may transmit an entrusted payment request to the device of the fund entrusted payment mechanism, and the entrusted payment request carries an entrusted payment type. The entrusted payment request is the first resource transfer request, and the entrusted payment type is the resource transfer type. The device of the fund entrusted payment mechanism may extract the entrusted payment type carried in the entrusted payment request, to detect whether the entrusted payment request is due entrusted payment or discount transfer entrusted payment. The device of the fund entrusted payment mechanism may create an entrusted payment bill, and store the entrusted payment bill in a database on the device of the fund entrusted payment mechanism. The entrusted payment bill is the resource transfer bill.

The entrusted payment request may further carry a transaction hash value, and the transaction hash value is correspondingly stored in a blockchain with asset information. The device of the fund entrusted payment mechanism may query the asset information corresponding to the transaction hash value on the blockchain based on the transaction hash value carried in the entrusted payment request. The asset information is the certificate of debt, and a blockchain system may return the asset information corresponding to the transaction hash value. The device of the fund entrusted payment mechanism may check information about the entrusted payment request based on asset information on the blockchain.

In the check process, the information to be checked also varies with different entrusted payment types. For example, if the entrusted payment type is the discount transfer entrusted payment, the information required to be checked may include deposit/withdrawal account-related information, bank information, and an asset share. The deposit/withdrawal account-related information corresponds to the transfer-in and transfer-out account information, the bank information corresponds to the creditor information of the target certificate of debt, and the asset share corresponds to the to-be-transferred resource. If the entrusted payment type is the due entrusted payment, the information to be checked may include deposit/withdrawal account-related information, a share, and an expiration time. The deposit/withdrawal account-related information corresponds to the transfer-in and transfer-out account information, the share corresponds to the to-be-transferred resource, and the expiration time is the expiration time of the target certificate of debt.

When it is determined that content of the entrusted payment request is correct through the check, the device of the fund entrusted payment mechanism may transmit a request to a bank or a petty cash bank through a payment interface, to obtain a withdraw bill, and the bank or petty cash bank may return a withdraw bill number. Subsequently, the device of the fund entrusted payment mechanism may further initiate a withdraw request through the payment interface, and the bank or petty cash bank may perform withdraw processing and return a withdraw result. Certainly, the device of the fund entrusted payment mechanism may alternatively return the result to the asset management platform, and the withdraw process is a process of the resource transfer.

Through the foregoing process, resource information on the blockchain is associated with the physical resource transfer, to implement the transfer of physical resources automatically, and a result is recorded on the blockchain. Therefore, a complete loop of an information flow and a fund flow may be closed online, thereby effectively preventing disconnection between the physical resource transfer and a digital resource on the blockchain in a payment process. It is unnecessary to record information such as resource transfer again manually, so that the resource transfer process is intelligent and automatic.

In the embodiments of this application, when a physical resource transfer request is received, verification may be performed on the physical resource transfer request based on resource information on a blockchain, and when the verification succeeds, physical resource transfer is performed. In the resource transfer process, the resource information on the blockchain is associated with the physical resource transfer, to implement the transfer of physical resources automatically. Therefore, a complete loop of an information flow and a fund flow may be closed online, thereby effectively preventing disconnection between the physical resource transfer and a digital resource on the blockchain in a payment process. It is unnecessary to record information such as resource transfer again manually, so that the resource transfer process is intelligent and automatic.

All the foregoing exemplary technical solutions may be arbitrarily combined to form an exemplary embodiment of this disclosure, and details are not described herein again.

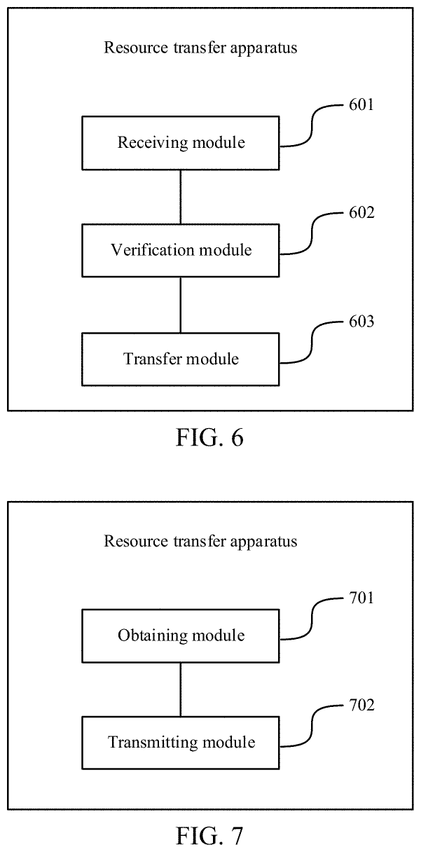

FIG. 6 is a schematic structural diagram of a resource transfer apparatus according to an embodiment of this disclosure. Referring to FIG. 6, the apparatus includes:

a receiving module 601, configured to receive a first resource transfer request, the first resource transfer request being used for requesting to perform a resource transfer associated with a target certificate of debt;

a verification module 602, configured to perform verification on the first resource transfer request according to the target certificate of debt stored in the blockchain system; and

a transfer module 603, configured to perform, based on the first resource transfer request, the resource transfer associated with the target certificate of debt, when the verification succeeds.

In a possible implementation, the verification module 602 is configured to:

determine, from the blockchain system according to a feature value carried in the first resource transfer request, a certificate of debt corresponding to the feature value as the target certificate of debt; and

compare transfer-in and transfer-out information in the target certificate of debt stored in the blockchain system with transfer-in and transfer-out information carried in the first resource transfer request.

In a possible implementation, the verification module 602 is configured to select, from the target certificate of debt stored in the blockchain system and according to a resource transfer type carried in the first resource transfer request, transfer-in and transfer-out information corresponding to the resource transfer type, to be compared with the transfer-in and transfer-out information carried in the first resource transfer request.

In a possible implementation, the verification module 602 is configured to:

select, when the resource transfer type is a first type, transfer-in and transfer-out account information, a to-be-transferred resource, and creditor information of the target certificate of debt from the target certificate of debt stored in the blockchain system, to be respectively compared with transfer-in and transfer-out account information, a to-be-transferred resource, and creditor information of the target certificate of debt that are carried in the first resource transfer request, the first type being used for instructing to perform a resource transfer in a generation condition of the target certificate of debt; or

select, when the resource transfer type is a second type, transfer-in and transfer-out account information, a to-be-transferred resource, and an expiration time of the target certificate of debt from the target certificate of debt stored in the blockchain system, to be respectively compared with transfer-in and transfer-out account information, a to-be-transferred resource, and an expiration time of the target certificate of debt that are carried in the first resource transfer request, the second type being used for instructing to perform, at the expiration time of the target certificate of debt, resource transfer indicated by the target certificate of debt.

In a possible implementation, the receiving module 601 is further configured to receive a request for resource information, the request for resource information being used for obtaining resource information in any account.

The apparatus further includes:

a first transmitting module, configured to obtain and transmit the resource information in the any account based on the request for resource information.

In a possible implementation, the apparatus further includes:

a second transmitting module, configured to transmit a resource transfer failure message when the verification fails.

In a possible implementation, the transfer module 603 is configured to transmit a second resource transfer request to a target device, and the target device performs the resource transfer based on the second resource transfer request, the second resource transfer request being used for instructing to perform the resource transfer requested in the first resource transfer request.

In a possible implementation, the verification module 602 is configured to determine, from the blockchain system and based on a hash value carried in the first resource transfer request, a certificate of debt corresponding to the hash value as the target certificate of debt.

In a possible implementation, the apparatus further includes:

an adding module, configured to generate a first block based on a result of the resource transfer associated with the target certificate of debt, and add the first block to a blockchain when the blockchain system reaches a consensus on the first block; or

an adding module, configured to generate a second block based on a result of the verification when the verification fails, and add the second block to a blockchain when the blockchain system reaches a consensus on the second block.

According to the apparatus provided in the embodiments of this application, when a physical resource transfer request is received, verification may be performed on the physical resource transfer request according to resource information on a blockchain, and when the verification succeeds, physical resource transfer is performed. In the resource transfer process, the resource information on the blockchain is associated with the physical resource transfer, to implement the transfer of physical resources automatically. Therefore, a complete loop of an information flow and a fund flow may be closed online, thereby effectively preventing disconnection between the physical resource transfer and a digital resource on the blockchain in a payment process. It is unnecessary to record information such as resource transfer again manually, so that the resource transfer process is intelligent and automatic.

Division of the foregoing functional modules is only described for exemplary purposes when the resource transfer apparatus provided in the foregoing embodiments performs resource transfer. In an actual application, the foregoing functions may be allocated to be accomplished by different functional modules according to requirements, that is, an internal structure of an electronic device is divided into different functional modules, to accomplish all or some functions of the above described functions. In addition, the resource transfer apparatus and resource transfer method embodiments provided in the foregoing embodiments belong to one conception. For a specific implementation process, refer to the method embodiments, and details are not described herein again.

FIG. 7 is a schematic structural diagram of a resource transfer apparatus according to an embodiment of this disclosure. Referring to FIG. 7, the apparatus includes:

an obtaining module 701, configured to obtain, when any certificate of debt meets a target condition, transfer-in and transfer-out information of a resource transfer associated with the certificate of debt;

the obtaining module 701 being further configured to obtain resource information in a transfer-out account in the transfer-in and transfer-out information; and

a transmitting module 702, configured to transmit a first resource transfer request based on the resource information and the transfer-in and transfer-out information, the first resource transfer request being used for instructing to perform verification on the first resource transfer request according to the certificate of debt stored in the blockchain system and perform, when the verification succeeds, the resource transfer associated with the certificate of debt.

In a possible implementation, the obtaining module 701 is configured to:

obtain, when the certificate of debt is generated and the certificate of debt has a generation condition, transfer-in and transfer-out information in the generation condition.

Correspondingly, the transmitting module 702 is configured to transmit the first resource transfer request when it is determined, according to the resource information, that the transfer-out account includes a to-be-transferred resource in the transfer-in and transfer-out information and a confirmation instruction of the transfer-out account is obtained, the first resource transfer request being used for instructing to perform a resource transfer in the generation condition of the certificate of debt.

In a possible implementation, the obtaining module 701 is configured to obtain, when a system time is an expiration time of the certificate of debt, transfer-in and transfer-out information of the resource transfer indicated by the certificate of debt.

Correspondingly, the transmitting module 702 is configured to transmit the first resource transfer request when it is determined, according to the resource information, that the transfer-out account includes a to-be-transferred resource in the transfer-in and transfer-out information, the first resource transfer request being used for instructing to perform, at the expiration time of the certificate of debt, the resource transfer indicated by the certificate of debt.

In a possible implementation, the obtaining module 701 is configured to:

transmit a request for resource information, the request for resource information being used for obtaining the resource information in the transfer-out account; and

receive the resource information in the transfer-out account.

In a possible implementation, the first resource transfer request carries a feature value of the certificate of debt, the first resource transfer request carries a resource transfer type, and the resource transfer type carried in the first resource transfer request varies with different transfer-in and transfer-out information.

According to the apparatus provided in the embodiments of this application, verification may be performed on a physical resource transfer request according to resource information on a blockchain, and when the verification succeeds, physical resource transfer is performed. In the resource transfer process, the resource information on the blockchain is associated with the physical resource transfer, to implement the transfer of physical resources automatically. Therefore, a complete loop of an information flow and a fund flow may be closed online, thereby effectively preventing disconnection between the physical resource transfer and a digital resource on the blockchain in a payment process. It is unnecessary to record information such as resource transfer again manually, so that the resource transfer process is intelligent and automatic.

Division of the foregoing functional modules is only described for exemplary purposes when the resource transfer apparatus provided in the foregoing embodiments performs resource transfer. In an actual application, the foregoing functions may be allocated to be accomplished by different functional modules according to requirements, that is, an internal structure of an electronic device is divided into different functional modules, to accomplish all or some functions of the above described functions. The term module may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module. A module is configured to perform predefined functions and achieve predefined goals such as those described in this disclosure, and may work together with other related modules, programs, and components to achieve those predefined functions and goals.

In addition, the resource transfer apparatus and resource transfer method embodiments provided in the foregoing embodiments belong to one conception. For a specific implementation process, refer to the method embodiments, and details are not described herein again.

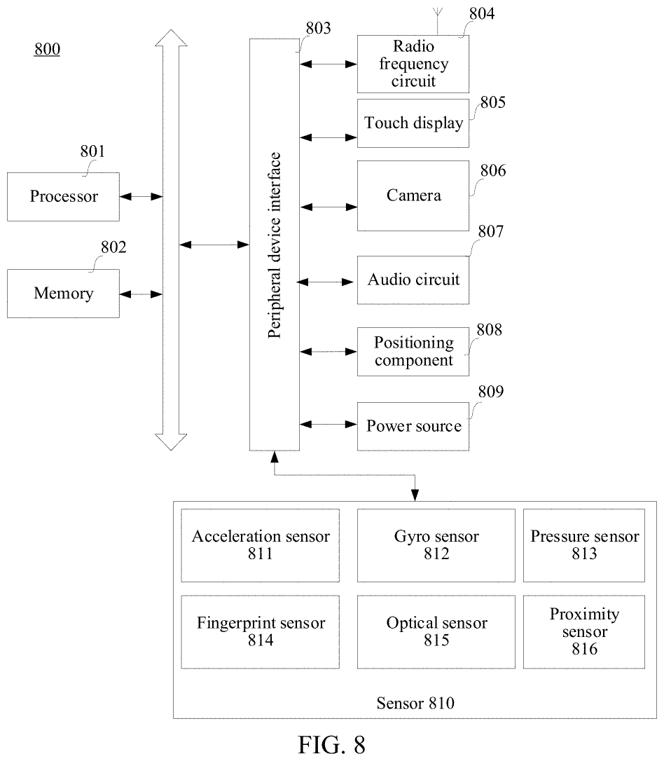

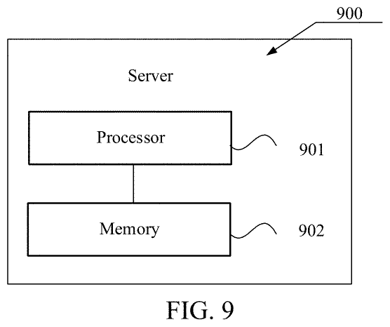

The electronic device may be provided as a terminal shown in FIG. 8, or may be provided as a server shown in FIG. 9. This is not limited in the embodiments of this application.

FIG. 8 is a schematic structural diagram of a terminal according to an embodiment of this disclosure. The terminal 800 may be a smartphone, a tablet computer, a Moving Picture Experts Group Audio Layer III (MP3) player, a Moving Picture Experts Group Audio Layer IV (MP4) player, a notebook computer, or a desktop computer. The terminal 800 may also be referred to as a user device, a portable terminal, a laptop terminal, a desktop terminal or the like.

Generally, the terminal 800 includes a processor 801 and a memory 802.

The processor 801 may include one or more processing cores, for example, a 4-core processor or an 8-core processor. The processor 801 may be implemented in at least one hardware form of digital signal processing (DSP), a field programmable gate array (FPGA), and a programmable logic array (PLA). The processor 801 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 801 may be integrated with a graphics processing unit (GPU). The GPU is responsible for rendering and drawing content to be displayed by a display screen. In some embodiments, the processor 801 may further include an artificial intelligence (AI) processor. The AI processor is configured to process a computing operation related to machine learning.

The memory 802 may include one or more computer-readable storage media. The computer-readable storage medium may be non-transient. The memory 802 may further include a high-speed random access memory and a nonvolatile memory, for example, one or more disk storage devices, or flash memory devices. In some embodiments, the non-transient computer-readable storage medium in the memory 802 is configured to store at least one computer-readable instruction, and the at least one computer-readable instruction is configured to be executed by the processor 801 to implement the resource transfer method provided in the method embodiments of this application.

In some embodiments, the terminal 800 may alternatively include: a peripheral device interface 803 and at least one peripheral device. The processor 801, the memory 802 and the peripheral device interface 803 may be connected by a bus or a signal line. Each peripheral device may be connected to the peripheral device interface 803 by the bus, the signal line, or a circuit board. Specifically, the peripheral device includes: at least one of a radio frequency (RF) circuit 804, a touch display 805, a camera 806, an audio circuit 807, a positioning component 808, and a power supply 809.

The peripheral device interface 803 may be configured to connect at least one input/output (I/O)-related peripheral device to the processor 801 and the memory 802. In some embodiments, the processor 801, the memory 802 and the peripheral device interface 803 are integrated on the same chip or circuit board. In some other embodiments, any one or two of the processor 801, the memory 802, and the peripheral device interface 803 may be implemented on a single chip or a circuit board. This is not limited in this embodiment.

The RF circuit 804 is configured to receive and transmit an RF signal, which is also referred to as an electromagnetic signal. The RF circuit 804 communicates with a communication network and other communication devices by using the electromagnetic signal. The RF circuit 804 converts an electrical signal into an electromagnetic signal for transmission, or converts a received electromagnetic signal into an electrical signal. Exemplarily, the RF circuit 804 includes: an antenna system, an RF transceiver, one or more amplifiers, a tuner, an oscillator, a digital signal processor, a codec chip set, a subscriber identity module card, and the like. The RF circuit 804 may communicate with other terminals through at least one wireless communication protocol. The wireless communication protocol includes, but is not limited to, a metropolitan area network, different generations of mobile communication networks (2G, 3G, 4G, and 5G), a wireless local area network, and/or a wireless fidelity (Wi-Fi) network. In some embodiments, the RF circuit 804 may also include a circuit related to near field communication (NFC). This is not limited in this application.

The display screen 805 is configured to display a user interface (UI). The UI may include a graphic, a text, an icon, a video, and any combination thereof. When the display 805 is the touch display, the display 805 also has the capability to collect a touch signal on or above a surface of the display 805. The touch signal may be inputted into the processor 801 as a control signal for processing. In this case, the display screen 805 may be further configured to provide a virtual button and/or a virtual keyboard, which is also referred to as a soft button and/or a soft keyboard. In some embodiments, there may be one display screen 805, disposed on a front panel of the terminal 800. In some other embodiments, there may be two display screens 805, respectively disposed on different surfaces of the terminal 800 or designed in a foldable shape. In still some other embodiments, the display screen 805 may be a flexible display screen, disposed on a curved surface or a folded surface of the terminal 800. Even, the display screen 805 may be further set to have a non-rectangular irregular graph, that is, a special-shaped screen. The display screen 805 may be manufactured by using a material such as a liquid crystal display (LCD), an organic light-emitting diode (OLED), or the like.

The camera component 806 is configured to collect an image or a video. Exemplarily, the camera component 806 includes a front-facing camera and a rear-facing camera. Generally, the front-facing camera is disposed on the front panel of the terminal, and the rear-facing camera is disposed on a back surface of the terminal. In some embodiments, there are at least two rear-facing cameras, each being any one of a main camera, a depth of field camera, a wide-angle camera, and a telephoto camera, to implement a Bokeh function through fusion of the main camera and the depth of field camera, panoramic photo shooting and virtual reality (VR) shooting functions through fusion of the main camera and wide-angle camera, or another fusion shooting function. In some embodiments, the camera component 806 may further include a flash. The flash may be a monochrome temperature flash, or may be a double color temperature flash. The double color temperature flash refers to a combination of a warm light flash and a cold light flash, and may be used for light compensation under different color temperatures.

The audio circuit 807 may include a microphone and a speaker. The microphone is configured to collect acoustic waves of a user and an environment, and convert the acoustic waves into an electrical signal to be inputted to the processor 801 for processing, or to be inputted to the radio frequency circuit 804 for implementing voice communication. For stereo collection or noise reduction, there may be a plurality of microphones, disposed at different portions of the terminal 800 respectively. The microphone may further be an array microphone or an omni-directional collection type microphone. The speaker is configured to convert an electrical signal from the processor 801 or the radio frequency circuit 804 into acoustic waves. The speaker may be a conventional film speaker, or may be a piezoelectric ceramic speaker. When the speaker is the piezoelectric ceramic speaker, the speaker not only can convert an electric signal into acoustic waves audible to a human being, but also can convert an electric signal into acoustic waves inaudible to a human being, for ranging and other purposes. In some embodiments, the audio circuit 807 may also include an earphone jack.

The positioning component 808 is configured to position a current geographic location of the terminal 800, to implement navigation or a location based service (LBS). The positioning component 808 may be a positioning component based on a global positioning system (GPS) of the United States, a COMPASS System of China, a GLONASS System of Russia, or a GALILEO System of the European Union.

The power supply 809 is configured to supply power to components in the terminal 800. The power supply 809 may be an alternating current, a direct current, a disposable battery, or a rechargeable battery. When the power supply 809 includes a rechargeable battery, the rechargeable battery may support wired charging or wireless charging. The rechargeable battery may be further configured to support a quick charge technology.

In some embodiments, the terminal 800 may also include one or more sensors 810. The one or more sensors 810 include, but are not limited to: an acceleration sensor 811, a gyro sensor 812, a pressure sensor 813, a fingerprint sensor 814, an optical sensor 815, and a proximity sensor 816.

The acceleration sensor 811 may detect the magnitude of acceleration on three coordinate axes of a coordinate system established by the terminal 800. For example, the acceleration sensor 811 may be configured to detect a component of gravity acceleration on the three coordinate axes. The processor 801 may control, according to a gravity acceleration signal collected by the acceleration sensor 811, the display screen 805 to display the user interface in a frame view or a portrait view. The acceleration sensor 811 may be further configured to collect motion data of a game or a user.

The gyroscope sensor 812 may detect a body direction and a rotation angle of the terminal 800. The gyroscope sensor 812 may cooperate with the acceleration sensor 811 to collect a 3D action by the user on the terminal 800. The processor 801 may implement the following functions according to the data collected by the gyro sensor 812: motion sensing (such as changing the UI according to a tilt operation of the user), image stabilization at shooting, game control, and inertial navigation.

The pressure sensor 813 may be disposed at a side frame of the terminal 800 and/or a lower layer of the touch display 805. When the pressure sensor 813 is disposed on the side frame of the terminal 800, a holding signal of the user on the terminal 800 may be detected. The processor 801 performs left and right hand recognition or a quick operation according to the holding signal collected by the pressure sensor 813. When the pressure sensor 813 is disposed on the low layer of the display screen 805, the processor 801 controls, according to a pressure operation of the user on the display screen 805, an operable control on the UI. The operable control includes at least one of a button control, a scroll-bar control, an icon control and a menu control.

The fingerprint sensor 814 is configured to collect a fingerprint of the user. The processor 801 identifies an identity of the user according to the fingerprint collected by the fingerprint sensor 814, or the fingerprint sensor 814 identifies an identity of the user according to the collected fingerprint. When identifying that the identity of the user is a trusted identity, the processor 801 authorizes the user to perform related sensitive operations. The sensitive operations include: unlocking a screen, viewing encryption information, downloading software, paying and changing a setting, and the like. The fingerprint sensor 814 may be disposed on a front surface, a rear surface, or a side surface of the terminal 800. When a physical button or a vendor logo is disposed on the terminal 800, the fingerprint 814 may be integrated with the physical button or the vendor logo.

The optical sensor 815 is configured to collect ambient light intensity. In an embodiment, the processor 801 may control display luminance of the touch display screen 805 according to the ambient light intensity collected by the optical sensor 815. Specifically, when the ambient light intensity is relatively high, the display luminance of the display screen 805 is increased. When the ambient light intensity is relatively low, the display luminance of the display screen 805 is reduced. In another embodiment, the processor 801 may further dynamically adjust a camera parameter of the camera component 806 according to the ambient light intensity collected by the optical sensor 815.

The proximity sensor 816, also referred to as a distance sensor, is generally disposed on the front panel of the terminal 800. The proximity sensor 816 is configured to collect a distance between the user and the front surface of the terminal 800. In an embodiment, when the proximity sensor 816 detects that the distance between the user and the front surface of the terminal 800 gradually becomes smaller, the touch display screen 805 is controlled by the processor 801 to switch from a screen-on state to a screen-off state. When the proximity sensor 816 detects that the distance between the user and the front surface of the terminal 800 gradually becomes larger, the touch display screen 805 is controlled by the processor 801 to switch from the screen-off state to the screen-on state.

A person skilled in the art may understand that a structure shown in FIG. 8 constitutes no limitation on the terminal 800, and the terminal may include more or fewer components than those shown in the figure, or some components may be combined, or a different component deployment may be used.

FIG. 9 is a schematic structural diagram of a server according to an embodiment of this disclosure. The server 900 may vary greatly due to different configurations or performance, and may include one or more processors (central processing units (CPUs)) 901 and one or more memories 902. The memory 902 stores at least one computer-readable instruction, the at least one computer-readable instruction being loaded and executed by the processor 901 to implement the resource transfer method provided in the foregoing method embodiments. Certainly, the server may further include components such as a wired or wireless network interface, a keyboard, and an input/output interface, to facilitate inputting/outputting. The server may further include other components configured to implement functions of a device, and details are not described herein again.

In an exemplary embodiment, a computer-readable storage medium, such as a memory including a computer-readable instruction, is further provided, and the computer-readable instruction may be executed by a processor to complete the resource transfer method in the foregoing embodiments. For example, the computer-readable storage medium may be a read-only memory (ROM), a random access memory (RAM), a compact disc ROM (CD-ROM), a magnetic tape, a floppy disk, an optical data storage device, or the like.

A person of ordinary skill in the art may understand that all or some of the steps of the foregoing embodiments may be implemented by using hardware, or may be implemented by a program instructing related hardware. The program may be stored in a computer-readable storage medium. The above-mentioned computer-readable storage medium may be a read-only memory, a magnetic disk, an optical disc, or the like.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for operating an electronic device in a blockchain system, the method comprising:
receiving a first resource transfer request, the first resource transfer request being used for requesting to perform a resource transfer associated with a target certificate of debt;
performing verification of the first resource transfer request according to the target certificate of debt stored in the blockchain system; and
performing, based on the first resource transfer request, the resource transfer associated with the target certificate of debt when the verification succeeds.

2. The method according to claim 1, wherein performing the verification of the first resource transfer request according to the target certificate of debt stored in the blockchain system comprises:
determining, according to a feature value carried in the first resource transfer request, a certificate of debt corresponding to the feature value as the target certificate of debt from the blockchain system; and
comparing transfer-in and transfer-out information of the target certificate of debt stored in the blockchain system with transfer-in and transfer-out information carried in the first resource transfer request.

3. The method according to claim 2, wherein comparing the transfer-in and transfer-out information of the target certificate of debt stored in the blockchain system with the transfer-in and transfer-out information carried in the first resource transfer request comprises:
selecting, from the target certificate of debt stored in the blockchain system and according to a resource transfer type associated with the first resource transfer request, the transfer-in and transfer-out information corresponding to the resource transfer type to compare with the transfer-in and transfer-out information associated with the first resource transfer request.

4. The method according to claim 3, wherein selecting, from the target certificate of debt stored in the blockchain system and according to the resource transfer type associated with the first resource transfer request, the transfer-in and transfer-out information corresponding to the resource transfer type to compare with the transfer-in and transfer-out information associated with the first resource transfer request comprises:
selecting, from the target certificate of debt stored in the blockchain system, transfer-in and transfer-out account information, a to-be-transferred resource, and creditor information of the target certificate of debt to respectively compare with transfer-in and transfer-out account information, a to-be-transferred resource, and creditor information of the target certificate of debt carried in the first resource transfer request when the resource transfer type associated with the first resource transfer request is used for instructing to perform a resource transfer in a generation condition of the target certificate of debt.

5. The method according to claim 3, wherein selecting, from the target certificate of debt stored in the blockchain system and according to the resource transfer type associated with the first resource transfer request, the transfer-in and transfer-out information corresponding to the resource transfer type to compare with the transfer-in and transfer-out information associated with the first resource transfer request comprises:
selecting transfer-in and transfer-out account information, a to-be-transferred resource, and an expiration time of the target certificate of debt from the target certificate of debt stored in the blockchain system to respectively compare with transfer-in and transfer-out account information, a to-be-transferred resource, and an expiration time of the target certificate of debt carried in the first resource transfer request when the resource transfer type associated with the first resource transfer request is used for instructing to perform resource transfer indicated by the target certificate of debt at the expiration time of the target certificate of debt.

6. The method according to claim 1, wherein performing, based on the first resource transfer request, the resource transfer associated with the target certificate of debt comprises:
transmitting a second resource transfer request to a target device, which providing a resource transfer service, to request the target device to perform the resource transfer based on the second resource transfer request, the second resource transfer request being used for instructing to perform the resource transfer requested in the first resource transfer request.

7. The method according to claim 1, further comprising:
generating a first block based on a result of the resource transfer associated with the target certificate of debt and adding the first block to a blockchain of the blockchain system when a consensus on the first block is reached in the blockchain system.

8. The method according to claim 1, further comprising:
generating a second block based on a result of the verification when the verification fails and adding the second block to a blockchain of the blockchain system when a consensus on the second block is reached in the blockchain system.

9. A method for operating an electronic device in a blockchain system, the method comprising:
obtaining, when any certificate of debt meets a target condition, transfer-in and transfer-out information of a resource transfer associated with the certificate of debt;
obtaining resource information in a transfer-out account in the transfer-in and transfer-out information; and
transmitting a first resource transfer request based on the resource information and the transfer-in and transfer-out information, the first resource transfer request being used for instructing to perform verification on the first resource transfer request according to the certificate of debt stored in the blockchain system and to perform, when the verification succeeds, the resource transfer associated with the certificate of debt.

10. The method according to claim 9, wherein obtaining the transfer-in and transfer-out information of the resource transfer associated with the certificate of debt comprises:
obtaining, when the certificate of debt is generated and the certificate of debt has a generation condition, transfer-in and transfer-out information in the generation condition.

11. The method according to claim 9, wherein transmitting the first resource transfer request based on the resource information and the transfer-in and transfer-out information comprises:
transmitting the first resource transfer request when it is determined, according to the resource information, that the transfer-out account comprises a to-be-transferred resource in the transfer-in and transfer-out information and a confirmation instruction of the transfer-out account is obtained, the first resource transfer request being used for instructing to perform a resource transfer in the generation condition of the certificate of debt.

12. The method according to claim 9, wherein obtaining the transfer-in and transfer-out information of the resource transfer associated with the certificate of debt comprises:
obtaining the transfer-in and transfer-out information of the resource transfer indicated by the certificate of debt when a system time is at an expiration time of the certificate of debt.

13. The method according to claim 9, wherein transmitting the first resource transfer request based on the resource information and the transfer-in and transfer-out information comprises:
transmitting the first resource transfer request when it is determined, according to the resource information, that the transfer-out account comprises a to-be-transferred resource in the transfer-in and transfer-out information, the first resource transfer request being used for instructing to perform the resource transfer indicated by the certificate of debt at an expiration time of the certificate of debt.

14. The method according to claim 9, wherein obtaining the resource information in the transfer-out account in the transfer-in and transfer-out information comprises:
transmitting a request for the resource information, the request for the resource information being used to obtain the resource information in the transfer-out account; and
receiving the resource information in the transfer-out account.

15. The method according to claim 9, wherein the first resource transfer request carries a feature value of the certificate of debt, the first resource transfer request carries a resource transfer type, and the resource transfer type carried in the first resource transfer request varies with different transfer-in and transfer-out information.

16. An electronic device, comprising a processor and a memory, the memory storing at least one computer-readable instruction, the computer-readable instruction being loaded and executed by the processor to perform the following steps, the steps comprising:
receiving a first resource transfer request, the first resource transfer request being used for requesting to perform a resource transfer associated with a target certificate of debt;
performing verification of the first resource transfer request according to the target certificate of debt stored in a blockchain system; and
performing, based on the first resource transfer request, the resource transfer associated with the target certificate of debt when the verification succeeds.

17. The electronic device of claim 16, wherein performing the verification of the first resource transfer request according to the target certificate of debt stored in the blockchain system comprises:
determining, according to a feature value carried in the first resource transfer request, a certificate of debt corresponding to the feature value as the target certificate of debt from the blockchain system; and
comparing transfer-in and transfer-out information of the target certificate of debt stored in the blockchain system with transfer-in and transfer-out information carried in the first resource transfer request.

18. The electronic device of claim 17, wherein comparing the transfer-in and transfer-out information of the target certificate of debt stored in the blockchain system with the transfer-in and transfer-out information carried in the first resource transfer request comprises:
selecting, according to a resource transfer type associated with the first resource transfer request, the transfer-in and transfer-out information corresponding to the resource transfer type from the target certificate of debt stored in the blockchain system to compare with the transfer-in and transfer-out information associated with the first resource transfer request.

19. The electronic device of claim 18, wherein selecting, from the target certificate of debt stored in the blockchain system and according to the resource transfer type associated with the first resource transfer request, the transfer-in and transfer-out information corresponding to the resource transfer type to compare with the transfer-in and transfer-out information associated with the first resource transfer request comprises:
selecting, from the target certificate of debt stored in the blockchain system, transfer-in and transfer-out account information, a to-be-transferred resource, and creditor information of the target certificate of debt to respectively compare with transfer-in and transfer-out account information, a to-be-transferred resource, and creditor information of the target certificate of debt carried in the first resource transfer request when the resource transfer type associated with the first resource transfer request is used for instructing to perform a resource transfer in a generation condition of the target certificate of debt.

20. A non-volatile computer-readable storage medium, storing at least one computer-readable instruction, the computer-readable instruction being loaded and executed by a processor to perform the method of claim 9.
